(19) United States
(12) Patent Application Publication
(10) Pub. No.: US 2016/0009507 A1
(43) Pub. Date: Jan. 14, 2016

(54) PORTABLE DEVICE FOR TRANSLOADING BULK MATERIAL

(71) Applicant: SIDEWINDER BULK SOLUTIONS, LLC, La Porte, TX (US)

(72) Inventors: Glenn Wiseman, Crosby, TX (US); Burt Lusk, Richmond, TX (US)

(21) Appl. No.: 14/328,272

(22) Filed: Jul. 10, 2014

(51) Int. Cl. B65G 67/08

(52) U.S. Cl. CPC B65G 67/08

(57) ABSTRACT

A portable transloading device for use with a vehicle, the transloading device transferring bulk material from a first container to a second container. The device includes a conveyor having a first section disposed parallel with the ground and a second section inclined with respect to said first section. A hydraulic motor is included to drive the conveyor. The hydraulic motor receives power from a secondary hydraulic system of the vehicle. The device further includes an attachment member having an attachment device for physically attaching the transloading device to the vehicle.

### FIELD OF THE INVENTION

The subject application relates to a device for transloading bulk materials from a first container to a second container.

### BACKGROUND OF THE INVENTION

Transportation of bulk materials, such as sand, gravel, stone, grain, or other particulate materials, by rail and/or road often involves transloading, simultaneously unloading the bulk material from a first container and loading the same bulk material into a second container. For example, bulk material may be transported by rail, then transloaded from a rail car to a truck for delivery to its final destination.

Conventional transloading devices include a fixed-frame conveyor system mounted on wheels. However, the devices have several limitations, most of which are related to their relatively poor mobility.

First, mobility of the conventional transloading devices on a job site is limited. In particular, conventional devices tend to be both slow and difficult to maneuver. The lack of speed creates delays moving the transloading device from one container to another. Moreover, once the device is roughly in position at an unloading point of a container, the lack of maneuverability makes it difficult to properly position the transloading device to catch bulk material being removed from the container at the unloading point. These properties reduce the throughput of each transloading device and lower the overall efficiency at the job site.

Further, because of the size and shape of conventional transloading devices, moving the devices between job sites often creates logistical difficulties. In particular, highway transportation may require special considerations to comply with state and/or federal transportation regulations. For example, particular equipment such as a truck with a drop-deck trailer may be needed to comply with height restrictions. Moreover, because of the size of the conventional transloader, special permits may be needed for transporting the device. It may also require an escort during transportation and the hours during which the device may be transported may be restricted. Thus, transportation of conventional transloaders can be difficult and time-consuming as well.

Accordingly, there is a need for a portable transloading device that is easily maneuverable at a job site and readily transported between multiple job sites without the need for special permits and equipment.

### BRIEF SUMMARY OF THE INVENTION

One or more of the above-listed needs are met or exceeded by the embodiments of the portable transloading device disclosed herein. The portable transloading device is attachable to a variety of general-purpose construction vehicles, making the present device highly maneuverable and relatively fast. Additionally, because of the mounting used on the vehicle, the device can be placed in a “travel mode” position to allow for easy transport of the device over rough terrain using only the vehicle, and transport over long distances using conventional hauling equipment (e.g. flatbed trailers) without need to acquire transportation permits.

In a first aspect, a portable transloading device is used with a vehicle for transferring bulk material from a first container to a second container. The device includes a conveyor having a first section disposed parallel with the ground and a second section inclined with respect to said first section. A hydraulic motor is included to drive the conveyor. The hydraulic motor receives power from a secondary hydraulic system of the vehicle. The device further includes an attachment member having an attachment device for physically attaching the transloading device to the vehicle.

Additional features and benefits of portable transloading device will become apparent from the drawings and detailed description of the preferred embodiments.

### BRIEF DESCRIPTION OF THE SEVERAL VIEWS OF THE DRAWINGS

FIG. 1 is a side elevation of an embodiment of a transloading device having a support cage;

FIG. 2 is an overhead plan view of the transloading device of FIG. 1;

FIG. 3 is side view of the transloading device of FIG. 1 in operation and connected to a vehicle; and

FIG. 4 is an overhead plan view of a second embodiment of a transloading device having an extended attachment plate.

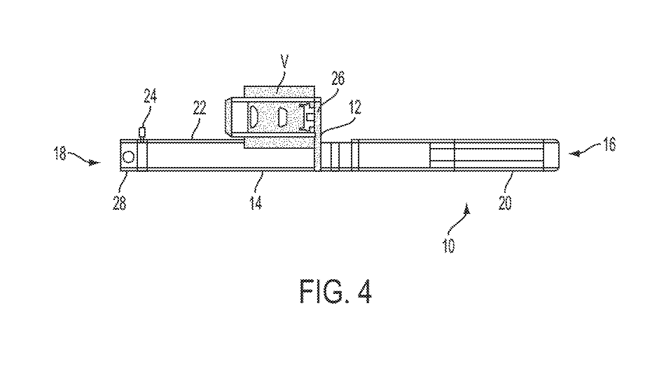

### DETAILED DESCRIPTION OF THE PREFERRED EMBODIMENTS

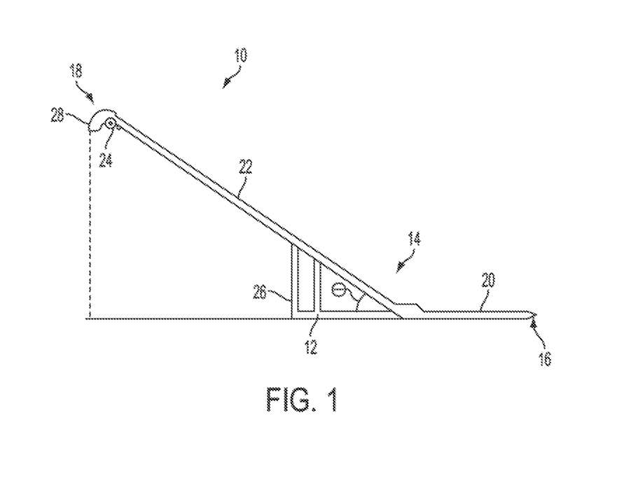

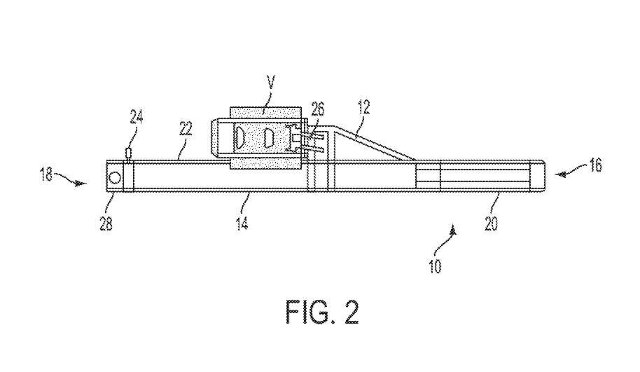

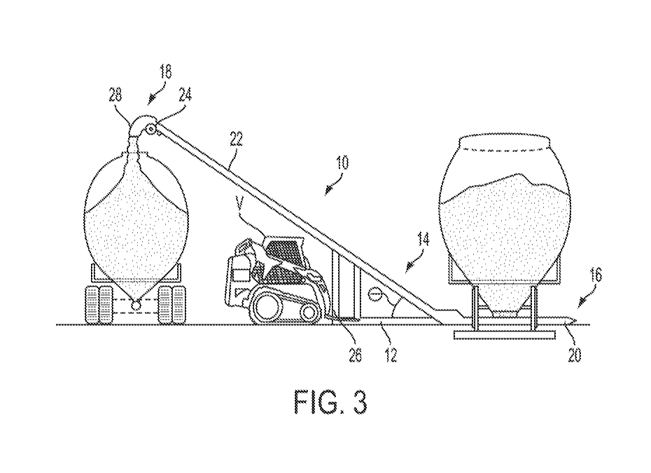

Turning to FIGS. 1-3, an embodiment of a portable transloading device, for transferring bulk material from a first container to a second container, is generally designated 10. The transloading device 10 includes an attachment member 12, such as a support cage or an extended attachment plate, and a conveyor 14. The device 10 includes an unloading end 16 that is used to unload bulk material from a first container and a loading end 18 used to load the bulk material into a second container. As shown in FIGS. 2-3, the device 10 interfaces with a separate vehicle V to provide power and locomotion capabilities. The vehicle V may be any of a number of general-purpose construction vehicles. For example, compact loaders, skid steers, and the like. A particular example of a vehicle for use with the device 10 is the T190 compact track loader produced by Bobcat Company. Those of skill in the art will appreciate, however, that other vehicles may be used.

The attachment member 12 is affixed to the conveyor 14 by known methods, such as bolts or other mechanical fasteners, welded joints, and the like. The Attachment member 12 is preferably formed from a relatively light and strong material. For example, aluminum C-channel material may be used. The material used to form the cage 12 is selected to provide structural integrity to the device 10, while still being light enough to be moved by the vehicle V. Other material types that meet these criteria may be used without departing from the scope of the invention.

The conveyor 14 is preferably a continuous flow single belt-driven conveyor including a first section 20 disposed at the unloading end 16 of the device 10 and a second section 22 extending from the first section to the loading end 18. The first section 20 has a width in a range of 12 to 42 inches, and more preferably 24 to 36 inches. A narrower width reduces an overall weight of the conveyor belt, thus reducing the power required to move the belt. The second section 22 preferably has a width set to match the width of the first section 20.

The conveyor 14 further includes one or more hydraulic motors 24 used to drive the belts of the first and second sections 20, 22. The motors 24 are in fluid communication with a secondary hydraulic pump on vehicle V, and convert the fluid flow of hydraulic fluid from the pump into torque and rotation, driving the conveyor 14. The motors 24 preferably drive the conveyor 14 to move bulk material at a rate of approximately 680 to 700 feet per minute.

In a first embodiment, the attachment member 12 is a support cage having a width that is at least as wide as that of the conveyor 14. It is further contemplated that the width of the cage varies, such that the width at the unloading side of the cage is approximately equal to the width of the conveyor 14, while the width at the loading side of the cage is substantially wider than the conveyor 14 to accommodate the vehicle V.

Alternatively, the attachment member 12 may be an extended attachment plate. The extended attachment plate 12 preferably has a width wider than the conveyor belt, such that the belt can be attached to the vehicle V in an offset position.

The vehicle V is mechanically connected to the attachment member 12 using an attachment device 24. The attachment device 24 may be, for example, a Quick Attach Plate as is known in the art, a coupler designed to interface with a pin grabber on boom arms of the vehicle V, a dedicated coupler designed to mate with a coupler on the vehicle boom arms, or the like. It is further contemplated that the attachment device may be a locking fork pocket designed to receive a set of palette forks from vehicle V. The attachment device 24 is offset relative to the conveyor 14 such that the conveyor 14 is disposed in an off-center position relative to the vehicle V. This allows the operator of the vehicle V to see the unloading end 16 of the conveyor 14 once the vehicle is attached to the attachment member 12.

As is known in the art, the vehicle V can be used to maneuver the device 10 in various ways. First, the vehicle V can be moved using its tracks and/or wheels. This movement changes the position of the vehicle, and thus the device 10, relative to a container to unload. The movement speed is limited only by the speed of the vehicle V, and is thus significantly faster than conventional transloaders.

Moreover, the vehicle V has hydraulically controlled boom arms to which the device 10 is coupled. Fine positioning of the device 10 is possible using the primary and secondary hydraulic controls on the vehicle to adjust the position of the boom arms.

The first section 20 of the conveyor 14 is designed to aid in unloading a first container, such as a railroad car container, which empties from the bottom, and optionally includes a grate or other sifting device to separate unwanted debris from the bulk material. The first section 20 preferably has a length in the range of 8-12 feet, with longer and shorter lengths also contemplated. The first section is preferably disposed approximately parallel to the ground, and has a relatively low profile, as the outlet from the first container may be near the ground. For example, the first section 20 may have a height of approximately six inches. A vehicle operator drives the vehicle into a position such that at least a portion of the first section 20 of the conveyor 14 is disposed at the outlet of the container. Bulk material from the container outlet falls onto the first section 20 of the conveyor 14. The hydraulic motor 24 causes the conveyor to move, thus transporting the bulk material toward the loading end of the device.

The bulk material then moves to the second section 22. The second section 22 moves the bulk material to the loading end 18. Preferably, the bulk material is then loaded into a top-loading container. To accomplish this, the second section 22 forms an angle θ with respect to the first section. The second section has a length and angle relative to the first section selected to allow for a second container to easily be located beneath the loading end of the device. For example, the second section may have a length of 30-35 feet, and an angle θ of 25°-30° relative to the first section. As a particular example, the second section may have a length of approximately 31 feet and an angle θ of approximately 30°.

The second section 22 optionally includes a material discharge port 28 at the loading end 18, as shown in FIGS. 1 and 2. The discharge port 28 helps to direct the bulk material toward the loading container and aids in loading.

Tilting the boom arms of vehicle V all the way back to a predefined stopping point tilts the conveyer 14 to a “travel mode” position. This position allows the conveyor 14 to be safely and easily transported by the vehicle V around a job site over rough terrain, over slopes and across longer distances (different sections of a rail yard containing multiple job sites) while reducing the overall conveyor height and balancing a load on the vehicle V. The “travel Mode” position also allows the transloader device 10 and vehicle V, as a unit, to be loaded and shipped with conventional equipment (e.g., 53′ vans/flatbeds) without requiring a special permit or escort, as height, width and weight are within current limitations. The device 10 may also be shipped separate from the vehicle V.

In operation, the transloader device 10 is mounted to the vehicle V using the attachment device 24. The vehicle allows for relatively quick movement of the device 10, when compared to conventional transloaders. The vehicle operator positions the vehicle so that at least a portion of the first section conveyor is beneath a first container that contains bulk material to be unloaded. The vehicle operator uses the hydraulic controls of the vehicle to easily refine the position of the transloader as needed. A second container is moved beneath the discharge port of the transloader to be loaded with bulk material, and the hydraulic motor is engaged such that the conveyor carries bulk material unloaded from the first container across the conveyor to be discharged into the second container. Bulk material is transported on the present portable transloading device at rates comparable to conventional transloaders. Once the first container has been emptied, the portable device can be moved to another container, or put into “travel mode” position and relocated to a different job site quickly and efficiently.

While a particular embodiment of the portable transloading device has been described herein, it will be appreciated by those skilled in the art that changes and modifications may be made thereto without departing from the invention in its broader aspects and as set forth in the following claims.

What is claimed is:

1. A portable transloading device for use with a vehicle, the transloading device transferring bulk material from a first container to a second container, comprising:
a conveyor having a first section disposed parallel with the ground and a second section inclined with respect to said first section;
a hydraulic motor for driving said conveyor, said hydraulic motor receiving power from a secondary hydraulic system of the vehicle;
an attachment member including an attachment device for physically attaching the transloading device to the vehicle.

2. The portable transloading device of claim 1, further comprising a discharge port disposed at an end of said second section.

3. The portable transloading device of claim 1, wherein said attachment device is offset relative to said conveyor.

4. The portable transloading device of claim 1, wherein said conveyor is belt-driven.

5. The portable transloading device of claim 1, wherein said first section has a length of approximately 10 feet.

6. The portable transloading device of claim 1, wherein said second section has a length in the range of 20-35 feet.

7. The portable transloading device of claim 1, wherein said second section forms an angle in the range of 25°-35° with respect to said first section.

8. The portable transloading device of claim 1, wherein said conveyor has a width in the range of 24-36 inches.

9. The portable transloading device of claim 1, wherein said hydraulic motor drives said conveyor at a rate of 680 to 700 feet per minute.

10. The portable transloading device of claim 1, wherein said attachment device is a quick couple device.

11. The portable transloading device of claim 1, wherein said attachment member is a support cage.

12. The portable transloading device of claim 1, wherein said attachment member is an extended attachment plate.

13. The portable transloading device of claim 1, wherein said conveyor is a continuous flow single belt conveyor.
